(19) United States
(12) Patent Application Publication
(10) Pub. No.: US 2009/0205574 A1
(43) Pub. Date: Aug. 20, 2009

(54) Method and apparatus for nursing animals

(76) Inventor: Sally H. Ross, Thibodaux, LA (US)

Correspondence Address: TED M. ANTHONY;BABINEAUX, POCHE, ANTHONY & SLAVICH, L.L.C, P.O. DRAWER 52169, LAFAYETTE, LA, 70505-2169, US

(21) Appl. No.: 12/378,570

(22) Filed: Feb. 17, 2009

Related U.S. Application Data
(60) Provisional application No. 61/066,070, filed on Feb. 15, 2008.

(51) Int. Cl. A01K 9/00

(52) U.S. Cl. 119/71

(57) ABSTRACT

A device for nursing animals is provided, generally having a form and size to simulate the mother of an animal that is to nurse from the device. The simulated animal nursing device has a body or torso area that defines a back, an underbelly and an opening that leads into an internal cavity. Holes or apertures extend through the underbelly of the body section. Nursing bottles having nursing nipples are positioned in inverted positions and supported within the internal cavity of the body section. The nursing nipples extend through the apertures, so that nursing animals can access the nipples and have a desirable nursing environment.

### CROSS REFERENCES TO RELATED APPLICATION

THIS APPLICATION CLAIMS THE BENEFIT OF U.S. PROVISIONAL PATENT APPLICATION NO. 61/066,070, FILED FEB. 15, 2008.

### STATEMENTS AS TO THE RIGHTS TO THE INVENTION MADE UNDER FEDERALLY SPONSORED RESEARCH AND DEVELOPMENT

NONE

INVENTOR: Sally H. Ross

### BACKGROUND OF THE INVENTION

1. Field of the Invention

The present invention relates to the nursing of animals. More particularly, the present invention relates to a method and apparatus for nursing animals that involves simulating a nursing animal (such as, for example, a mother) to provide an appealing environment to encourage nursing by newborn animals.

2. Brief Description of the Prior Art

Animal rescue workers, veterinarians, pet owners, animal breeders and others who work with animals frequently face difficulties feeding newborn animals. Such difficulties are especially prevalent with newborn animals that become separated from their mothers. Such newborn animals can include, but are not necessarily limited to, orphaned or stray animals. In such cases, newborn animals must often be fed by hand.

Unfortunately, newborn animals frequently do not eat well when fed by hand and/or when human intervention is involved. In most cases, such newborn animals prefer to receive their nourishment directly from another animal, rather than from a bottle or other dispenser. Further, it has been observed that such animals typically prefer to feed in a warm area where they can snuggle and place their forepaws, and where they can have a soft surface to push against with their noses.

Various feeding devices exist that can be used to simulate a nursing mother or other animal. However, such existing devices have proven to have a number of limitations, and do not provide the novel benefits of the present invention disclosed herein.

### SUMMARY OF THE PRESENT INVENTION

The method and apparatus of the present invention comprises a simulated animal having approximately the same dimensions and characteristics as those of a mother for the newborn animals that are to be fed using said apparatus. In most cases, a conventional stuffed animal having a soft outer covering (such as, for example, real or simulated fur) can be used. Although such a stuffed animal can be made specifically for this purpose, in many cases it can be beneficial to utilize an existing stuffed animal that is manufactured for another purpose. By way of example, but not limitation, it may be possible to utilize a conventional stuffed animal that is manufactured to serve as a child's toy.

In cases where an existing stuffed animal is used, an incision is typically made in the outer coating (“fur”) of the stuffed animal. Although such an incision can be made in a number of different locations, in the preferred embodiment of the present invention the incision is beneficially located along the back portion of the stuffed animal, in the general vicinity where the mother animal's spine would be located (that is, the portion along the body of the stuffed animal that is opposite from its belly). Thereafter, a portion of the stuffing or other internal filler material can be removed from the torso area of the stuffed animal to provide an internal cavity within said torso area. In most cases, any stuffing or other filler material in the limbs, head and/or tail of the stuffed animal is not removed and is beneficially permitted to remain in place.

In the preferred embodiment, a reinforcing material can be placed inside the open torso of the stuffed animal along the belly area of said animal. Although not absolutely required, such reinforcing material is typically preferred because it can strengthen and reinforce the portion of the stuffed animal that comes in most frequent and direct contact with nursing animals. Such reinforcing material can also support nursing container(s), as more fully set forth herein. By way of illustration, but not limitation, it is to be observed that said reinforcing material may be a sturdy fabric or liner, such as muslin or other fabric exhibiting similar characteristics. In the preferred embodiment, said reinforcing material can be sewn in place or otherwise attached to said stuffed animal.

At least one aperture extends through the outer covering of the stuffed animal, as well as any reinforcing material. In the preferred embodiment, said at least one aperture has a substantially round or circular shape. Further, in the preferred embodiment, a reinforcing eyelet (typically constructed of metal, hard plastic or similar material) encircles each of said at least one apertures. Such reinforcing eyelet(s) help prevent said at least one apertures from tearing or spreading to create larger openings.

In the preferred embodiment, a nursing bottle support housing is provided. Although said support housing can take various different shapes and sizes, in the preferred embodiment said bottle support housing has an elongate and substantially cylindrical shape. Further, in the preferred embodiment, said support housing is generally sized to conform to appropriate dimensions of a stuffed animal in which it is to be employed; such that when said bottle support housing is received within the body section of a stuffed animal, said animal will appear substantially similar to its original size and shape prior to the removal of any stuffing and/or filler material.

In the preferred embodiment, said bottle support housing is constructed of foam (such as, for example, a high-density polyurethane foam material). A plurality of bores is disposed in said bottle support housing; in the preferred embodiment, each of said bores is oriented substantially perpendicular to the longitudinal axis of said bottle support housing, and is sized to receive and hold a nursing bottle.

Once the bore(s) of said bottle support housing are loaded with the desired number of nursing bottles, said bottle support housing is inserted into the open body section or torso of the stuffed animal via the opening in the back of said animal. In the preferred embodiment, the foam bottle support housing “fills in” the body section of the stuffed animal, making the dimensions of said animal appear more lifelike.

In most cases, each of said nursing bottles include a nipple extension. In the preferred embodiment, the nipple extension of each such nursing bottle extends through said bottle support housing and protrudes out an aperture in the body of the stuffed animal. In this manner, each such nipple extension extends out of the belly section of the stuffed animal, approximating the placement of nipples on a real animal. The longitudinal opening along the back of the stuffed animal is then closed with a conventional fastener means such as snaps, hooks, laces, zipper, hook-and-loop (e.g., Velcro®), or the like. If desired, the fur/coat on the outer surface of the stuffed animal can be trimmed in the vicinity of the protruding nipples to improve access to said nipples by a nursing animal.

An object of the present invention is to provide a simulated animal nursing device that is simple, inexpensive and easy to use. The present invention provides a simulated animal nursing device in the form and size of an actual mother, so as to replicate as much as possible a desirable nursing environment for newborn animals. The simulated animal nursing device of the present invention can be beneficially substituted for an actual mother, if the actual mother is not available to feed such newborn animals.

### BRIEF DESCRIPTION OF THE DRAWINGS

The foregoing summary, as well as the following detailed description of the preferred embodiments, is better understood when read in conjunction with the appended drawings. For the purpose of illustrating the invention, the drawings show certain preferred embodiments. It is understood, however, that the invention is not limited to the specific methods and devices disclosed.

FIG. 1 depicts an overhead view of an animal feeding on the animal nursing apparatus of the present invention.

FIG. 2 depicts a sectional view of the animal nursing apparatus of the present invention along line 2-2 of FIG. 1.

FIG. 3 depicts an exploded view of the animal nursing apparatus of the present invention.

FIG. 4 depicts a perspective view of a bottle support housing of the present invention.

FIG. 5 depicts a partial cut-away view of a nursing apparatus of the present invention.

### DETAILED DESCRIPTION OF A PREFERRED EMBODIMENT OF THE INVENTION

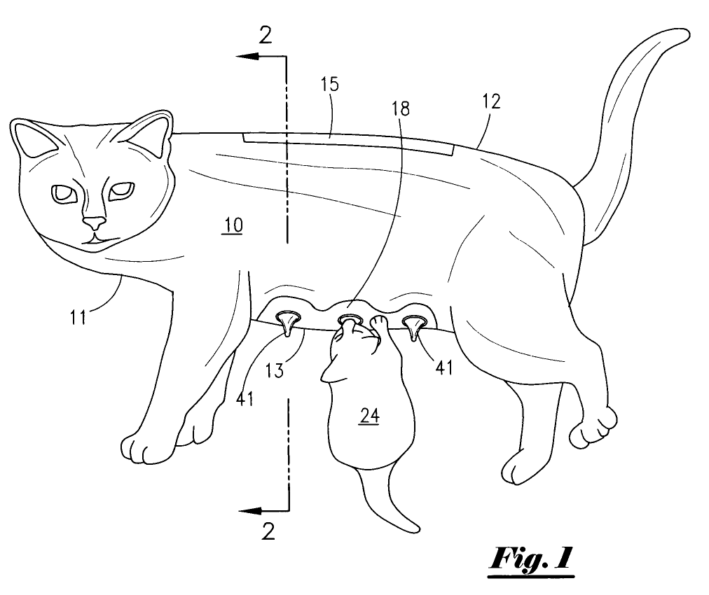

Referring to the drawings in detail, FIG. 1 depicts a side view of the nursing apparatus of the present invention. The present invention comprises a stuffed animal form 10 having outer covering 11. In the preferred embodiment, outer covering 11 of form 10 comprises a soft, resilient, fur-like material and has the general shape and configuration of a mammalian mother. By way of illustration, but not limitation, a cat shape is depicted in FIG. 1; however, it is to be observed that animal form 10 can take the shape and configuration of many different types of animals including, without limitation, a dog, pig or the like. Form 10 includes a body section defining back section 12 and bottom section (or “underbelly”) 13. Back section 12 of form 10 generally represents an animal mother's back, while bottom section 13 of form 10 generally represents an animal mother's underbelly where nursing nipples would ordinarily be situated.

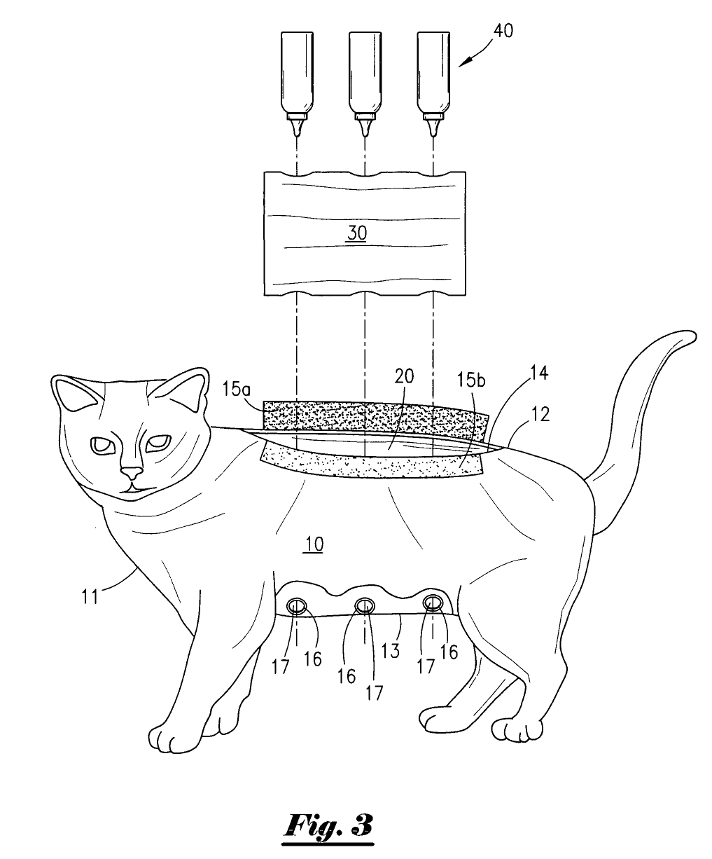

Still referring to FIG. 1, at least one nursing nipple 41 protrudes from underbelly or bottom section 13 of stuffed animal form 10, thereby allowing access to said at least one nursing nipple 41 by one or several animals to be nursed (such as kitten 24 depicted in FIG. 1). In this manner, each such nursing nipple 41 extends from underbelly section 13 of stuffed animal form 10, approximating the placement of nipples on a real animal. In the preferred embodiment, a longitudinal opening (seen better in FIG. 3) extends along back section 12 of stuffed animal form 10, and can be secured in a closed position with a hook-and-loop (e.g., Velcro®) fastener 15. If desired, fur on the outer surface of animal form 10 can be trimmed back in area 18 on underbelly 13 in the vicinity of the protruding nursing nipples 41 to facilitate easier access to said nipples 41 by a nursing animal (such as kitten 24).

Referring to FIG. 3, an exploded view of the animal nursing apparatus of the present invention comprising outer covering 11 of animal form 10 having the general shape and configuration of a mammalian mother (a cat in this case) is depicted. Animal form 10 defines a simulated animal body having back section 12 and bottom underbelly 13. Longitudinal opening 14 extends along back section 12 of stuffed animal form 10, and can be conveniently opened or, alternatively, secured in a closed position using hooks on flap 15a and loops on surface 15b.

Still referring to FIG. 3, outer covering 11 of form 10 defines internal cavity 20 in the vicinity of the body section of form 10 that can be accessed by means of longitudinal opening 14. In the preferred embodiment, at least one substantially circular aperture 17 extends from internal cavity 20 and through outer covering 11 at or near underbelly 13. Further, in the preferred embodiment, a reinforcing eyelet 16 (typically constructed of metal, hard plastic or similar material) encircles each of said at least one apertures 17. Reinforcing eyelets 16 help prevent said apertures from tearing or spreading to create larger openings.

Still referring to FIG. 3, bottle support housing 30 is provided. Although said bottle support housing 30 can take many different shapes and sizes, in the preferred embodiment said bottle support housing 30 has a substantially cylindrical shape. Further, in the preferred embodiment, said bottle support housing 30 is generally sized to conform to appropriate dimensions of internal cavity 20; such that when said bottle support housing 30 is received within internal cavity 20 of animal form 10, animal form 10 will have the general appearance (including shape and dimensions) of a desired animal mother being simulated. In the preferred embodiment, said bottle support housing 30 is constructed of soft but formable material (such as, for example, a high-density polyurethane foam material).

Referring to FIG. 4, a perspective view of elongate and substantially cylindrical bottle support housing 30 of the present invention is depicted. In the preferred embodiment, a plurality of substantially cylindrical bores 31 is disposed through said bottle support housing 30; in the preferred embodiment, each of said bores 31 is oriented substantially perpendicular to the longitudinal axis of said bottle support housing 30, and is sized to receive and hold a nursing bottle. Further, in the preferred embodiment of the present invention, said bores 31 are spaced to align with apertures 17 that extend through outer covering 11 of animal form 10 at underbelly 13.

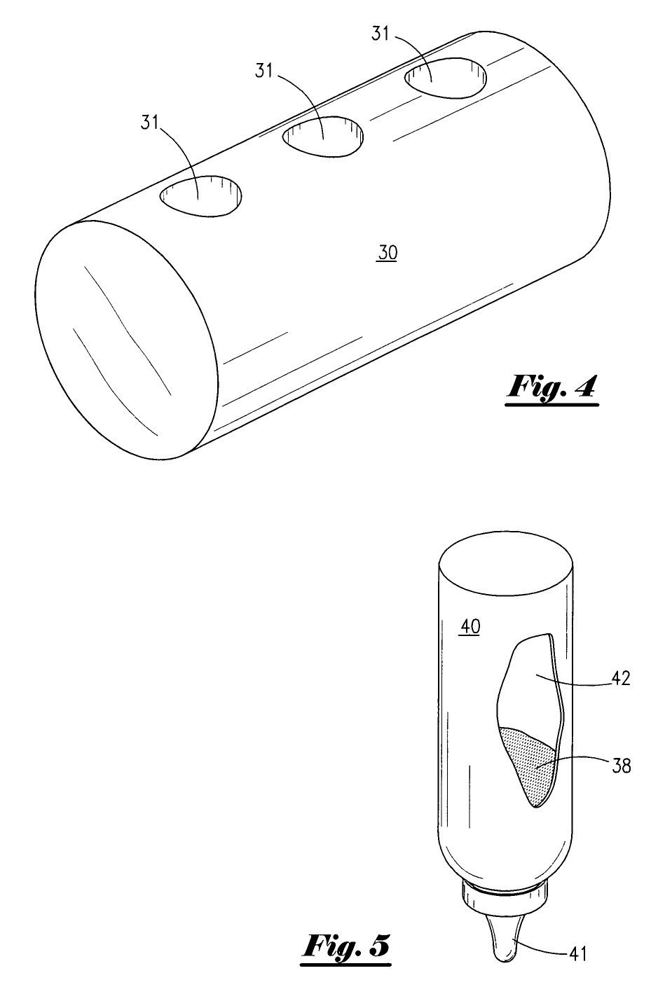

FIG. 5 depicts a partial cut-away view of a nursing bottle 40 of the present invention comprising fluid reservoir 42 and flexible nursing nipple 41. Although said nursing bottle 40 can embody many different shapes and/or sizes, in the preferred embodiment nursing bottle 40 is beneficially sized to fit snuggly yet comfortably within a bore 31 of bottle support housing 30. Fluid reservoir 42 can serve as a container for milk or other nutrient-containing fluid 38. Nursing nipple 41 is beneficially sized to dispense the appropriate quantities of such milk or other fluid 38 to animals suckling on said nursing nipple 41.

Referring back to FIG. 3, once the desired number of nursing bottle(s) 40 are loaded within bores 31 of bottle support housing 30, bottle support housing 30 can be inserted into internal cavity 20 of stuffed animal form 10 via opening 14. In the preferred embodiment, the foam of bottle support housing 30 “fills in” the body section of the stuffed animal form 10, making it appear more lifelike. Nursing nipples 41 extend out of the bottom of said bores 31. Because said bores 31 are spaced to align with apertures 17 extending through outer covering 11 of animal form 10 at underbelly 13, nursing nipples 41 protrude out of apertures 17 and beneficially extend beyond outer covering 11.

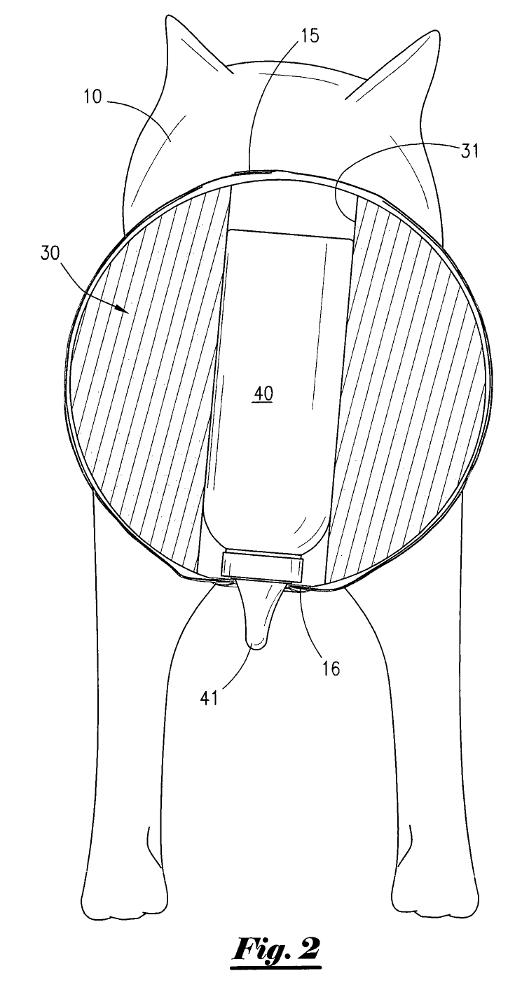

Referring to FIG. 2, a sectional view of the animal nursing apparatus of the present invention is depicted along line 2-2 of FIG. 1. Nursing bottle 40 is received within bore 31 of bottle support housing 30, and bottle support housing 30 is in turn inserted into internal cavity 20 of stuffed animal form 10. In the preferred embodiment, the foam of bottle support housing 30 “fills in” the body section of the stuffed animal form 10, making such body section appear more lifelike. Nursing nipple 41 of nursing bottle 40 protrudes outward through aperture 17 in the body of stuffed animal form 10, allowing nursing animals to access said nursing nipple 41. Longitudinal opening 14 (not visible in FIG. 2) can be secured in a closed position using fastening means 15.

In the preferred embodiment, a reinforcing material can be placed inside internal cavity 20 and disposed along the inner surface of outer covering 11 in the vicinity of underbelly 13. Although not absolutely required, such reinforcing material can strengthen and reinforce the portion of animal form 10 that comes in most frequent and direct contact with nursing animals. By way of illustration, but not limitation, it is to be observed that said reinforcing material may be a sturdy fabric or liner, such as muslin or other fabric exhibiting similar characteristics. In the preferred embodiment, said reinforcing material can be sewn in place within internal cavity 20.

The above described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

What is claimed:

1. An animal nursing apparatus comprising:
a) an animal form having an outer skin and a body section, said body section defining a back, an underbelly and an internal cavity, and at least one aperture extending through said outer skin at said underbelly;
b) an elongate bottle support member disposed within said internal cavity and having at least one bore extending through said bottle support member, wherein said at least one bore is oriented substantially perpendicular to the longitudinal axis of said elongate bottle support member and is aligned with said at least one aperture extending through said outer skin; and
c) at least one bottle having a nursing nipple, wherein said at least one bottle is disposed within said at least one bore, and said nursing nipple is received in said at least one aperture and extends beyond said outer skin.

2. The animal nursing apparatus of claim 1, wherein said bottle support member is constructed of foam.

3. The animal nursing of apparatus of claim 1, further comprising a rigid eyelet disposed around said at least one aperture.
